(19) United States
(12) Patent Application Publication
(10) Pub. No.: US 2015/0154005 A1
(43) Pub. Date: Jun. 4, 2015

(54) Methods and Apparatuses for Performing Multiplication

(71) Applicants: Kuo-Tseng Tseng, San Jose, CA (US); Parkson Wong, Los Altos, CA (US)

(72) Inventors: Kuo-Tseng Tseng, San Jose, CA (US); Parkson Wong, Los Altos, CA (US)

(21) Appl. No.: 14/557,368

(22) Filed: Dec. 1, 2014

Related U.S. Application Data
(60) Provisional application No. 61/910,509, filed on Dec. 2, 2013.

(51) Int. Cl. G06F 7/58; G06F 7/523

(52) U.S. Cl. CPC G06F 7/58; G06F 7/523; G06F 2207/58

(57) ABSTRACT

In a novel computation device, a plurality of partial product generators is communicatively coupled to a random number. The random number is partitioned in the computation device into non-overlapping subsets of binary bits and each subset is coupled to one of the plurality of partial product generators. Each partial product generator, upon receiving a subset of binary bits representing a number, generates a multiplication product of the number and a predetermined constant. The multiplication products from all partial product generators are summed to generate the final product between the predetermined constant and the random number.

### BACKGROUND

Multiplication is a fundamental arithmetic operation done with pen and paper and with computer. It is also a subject of intense research in the art of computer science and engineering.

Multiplication involves two operands—the multiplicand and the multiplier. Traditionally multiplication is performed by first taking each digit of the multiplier and multiplies it sequentially with the digits in the multiplicand to generate a partial product. Next the partial products are aligned with proper “shifts” according to the position of the digits in the multiplier. Finally the aligned partial products are “added” to arrive at the final product.

Pen-on-paper is viable when the operands are simple, but it becomes only practical to use a computer or other electronic computation devices when they are not, especially when calculation speed is essential.

Even though the “add and shift” algorithm is straight forward, its implementation in electronic form still may take a large amount of hardware components and relatively long time when the operands are non-trivial and high precision of the result is necessary. Computer scientists and engineers have endeavored to speed up the operation. For example, Andrew Donald Booth published an important work directed to a multiplication algorithm in 1951 and his method has been followed and expanded ever since.

For illustrative purpose, a brief account of the Booth's algorithm commonly known as Booth 2 is presented herein. First, the multiplier is partitioned and decoded into overlapping groups of 3-bit binary numbers which may be stored in a computer memory unit after the multiplier arrives at the computing unit. Each group is then multiplied successively with the multiplicand when it arrives at the computing unit. The partial products of each of the 3-bit multipliers and the multiplicand may be stored, for example, again in memory unit. The partial products are then “shifted and aligned” in a binary adder and are added to arrive at the final product.

Comparing to the rudimentary digit-by-digit approach, the Booth 2 method reduces the number of partial products by almost a half, or more precisely, from n to (n+2)/2, where n is the length of the multiplier in number of binary bits. Other versions of the Booth's algorithm, such as Booth 3, Booth 4, and Redundant Booth are known in the art. These successively sophisticated algorithms improve the multiplication but only incrementally.

### SUMMARY OF THE INVENTION

The present Inventors recognized that, with ail known methods of doing multiplication electronically, the two operands—the multiplicand and the multiplier—are often generated temporally separately and they may even be generated at different portions of the machine. It is very likely that they may be transferred via different paths and may arrive at the multiplication circuitry at different times. One bottleneck that slows down the process is that the machine has to hold the first arriving operand in storage and waits for the arrival of the second operand before the multiplication operation can commence. Even when one of the operand is known ahead of time, it stays stored passively in the machine waiting for the arrival of the second operand and the multiplication operation still does not start until the other operand arrives. The waiting time is non-productive.

Another speed bottleneck is that the actual multiplication steps still must be performed in a row by row fashion not very different from the pen-on-paper way.

With this realization, the Inventors invented methods and apparatuses which can be implement on computers and other electronic devices and in essence eliminate the two speed bottlenecks in doing multiplication. The inventive methods require only a small fraction of computing steps and the inventive apparatuses can be built with hardware components known in the art simply and at relatively low cost, even in a single IC chip.

One aspect of this invention involves a method that prepares partial products based only on the first available operand and thus eliminates the wait time. When one of the operands is a predetermined and frequently encountered constant the one can build a partial product generator that is dedicated to the constant and further speed up the multiplication operation.

Another aspect of this invention is directed to a partial product generator (PPG) implemented in hardware that generates products of a known number and a random number. This virtually eliminates the previously time-consuming bit by bit multiplication.

Another aspect of this invention is directed to an apparatus that includes a look-up table for storing the partial products of a known multiplicand. The look-up table may be so configured that the partial products stored therein are readily accessible and selectable according to the multiplier to produce the final product of the two operands expeditiously.

Another aspect of this invention is directed to methods of multiplication that eliminate the unnecessary wait time and reduce the computation time. One example method starts by providing a partial product generator (PPG) of the multiplicand. Binary signals representing the multiplier are communicated to the partial product generator. The outputs of the partial product generator are then conveyed to an adder where they are manipulated to arrive at the final product.

Another aspect of this invention is directed to such a partial product generator (PPG), which may be implemented by an aggregate of random logic elements such as AND gate, OR gate, etc., laid out in a portion of an integrated circuit chip or they may be dispersed in opportunistic locations in the chip. Alternatively, instead of using random logic element, the partial products of the constant multiplicand may be a block of arrayed memory device such as ROM or RAM, which also functions as the look-up table assessable to the adder.

Another aspect of this invention involves the method, which decodes and partitions the multiplier into groups of bits of specific radix that is congruent to the generation of the partial products. In the example of radix 4, the method partitions and decodes the multiplier into groups of 2-bit binary numbers and conveys them as addresses to select among the stored partial products. The selected partial products are transferred to a carry-save adder tree and a final adder to produce the final product.

These and other aspects of the invention will be further illustrated by the drawing figures and set forth in more detail with examples more fully described along with drawing figures in later sections of this paper.

### BRIEF DESCRIPTION OF DRAWINGS

FIG. 1 depicts a multiplication of two 16-bit numbers in known art.

FIG. 2 depicts an example of the “shift and add” method in known art.

FIG. 3 depicts a block diagram illustrating a multiplication operation according to this invention.

FIG. 4 depicts an example of a radix 4 partial product generator (PPG) for multiplying the constant π/2 according to this invention.

FIG. 5 depicts a block diagram illustrating another multiplication operation according to this invention.

FIG. 6 depicts an example of a radix 8 partial product generator (PPG) for multiplying the constant π/2 according to this invention.

FIG. 7 depicts an example of a radix 4 partial product generator PPG) for multiplying the constant 1/LN(2),according to this invention.

FIG. 8 depicts an example of a radix 8 partial product generator (PPG) for multiplying the constant 1/LN(2) according to this invention.

### DETAILED DESCRIPTION OF EMBODIMENTS

### Example 1

### Multiplication by Shift and Add

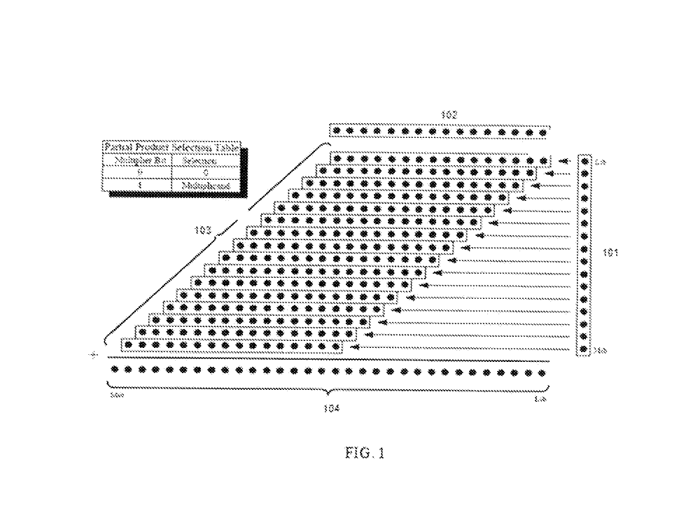

FIG. 1 depicts the multiplication of two 16-bit binary numbers as known in the art. This method starts with, the arrangement of the multiplier 101. In FIG. 1, the 16 bits of the multiplier 101 is figuratively arranged vertically with the least significant bit (LSB) on the top and the most significant bit (MSB) on the bottom; and the multiplicand 102 arranged figuratively horizontally with the LSB on the right end and the MSB on the left end. Each bit of the multiplier is then interrogated successively starting from the least significant bit. If the bit is a “one”, the partial product 103 is a duplicate of the multiplicand and is posted against the multiplier bit; if the bit is a zero, then the partial product 103 is a string of zeros. This process is repeated for the all bits of the multiplier bit by bit. Each string posting is accompanied by a “shift” of one bit to the left with respect to the string immediately above it.

Each black dot in FIG. 1 is a placeholder for a single bit which can be a zero or one. Each horizontal row of dots 103 represents a copy of the multiplicand, M, or a string of zeros.

After the “partial multiplication” of all the bits in the multiplier are finished and the posting of the “partial products” 103 with the proper “shifting” are properly aligned, the “add” is performed to add the partial products with the proper carry to arrive at the final product of the multiplication 104, which is represented by the row of 32 horizontal dots at the bottom.

Roughly speaking, the number of dots (256 in this example) is proportional to the amount of hardware required. Time multiplexing can reduce the amount of hardware at the cost of slower operation. The latency of an implementation of this method is relates to the height of the partial product section (i.e. the maximum number of dots in any vertical column, 16 in this example) of the dot diagram.

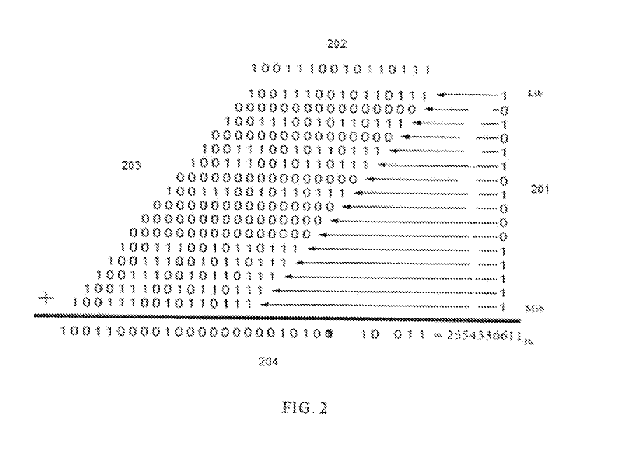

FIG. 2 depicts an example of this “shift and add” method using two numbers: the multiplier is 40119 and the multiplicand is 63669. In binary representation, the multiplier 201 is 1111100010110101 and the multiplicand 202 is 1001110010110111. The partial products 203 are shown as properly shifted and aligned. After the “adding” operation, the final product 104, which is 2554336611, is achieved at the bottom of FIG. 2.

### Example 2

### Multiplication of Constant π/2 to a 16 Bit Random Number

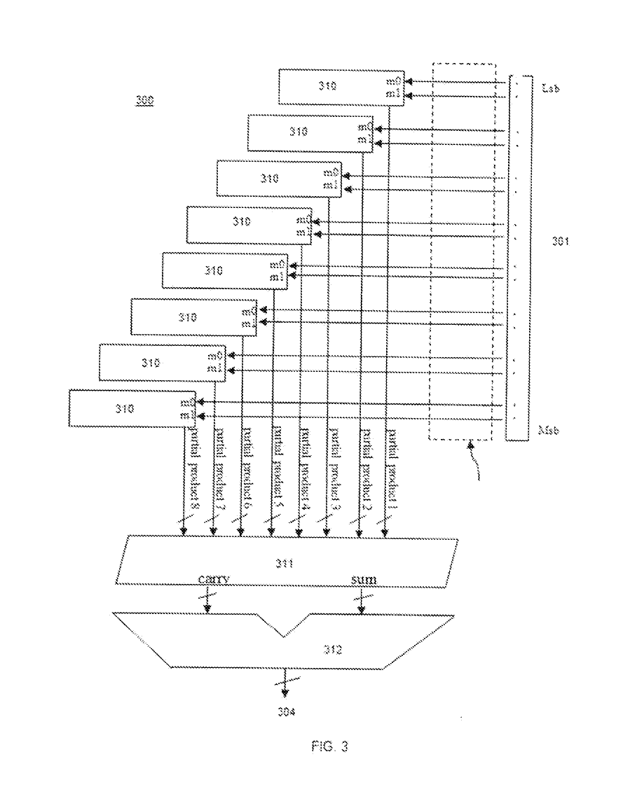

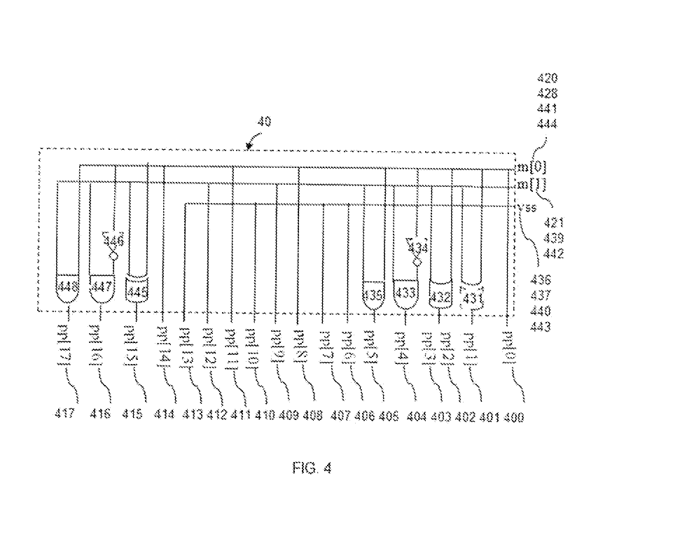

FIGS. 3 and 4 depict an illustrative embodiment of this invention, in which a constant is multiplied to a 16 bit number 301. The constant chosen for the illustrative embodiment is 1.57077, which is approximately one half of the irrational number π. In binary representation, the number 1.57077 is expressed by an 18 bit binary number 00 1100 1001 0000 1111.

The partial product generator PPG 310 in this example is configured with a 18-bit output terminals and a 2-bit input terminals according to the chosen radix 4.

This exemplary PPG may be constructed in a single integrated circuit chip with logic elements such as ADD gates, OR gates, XOR gates, INVETERs, and wires, all of which are known in the art of computer engineering. In the following description, the notation pp[m] designates the m^{th} of the 18 outputs of the PPG; and m[0] is the least significant bit and m[1] is the most significant bit of the 2-bit multiplier subsets.

The binary representation of the constant π/2 is 1.100100100001111. The partial products of π/2 and the two-bit binary numbers 00, 01, 10, and 11 are listed in the equations below in 18 bits:

11×π/2=100101101100101101 (1)

10×π/2=011001001000011110 (2)

01×π/2=001100100100001111 (3)

00×π/2=000000000000000000 (4)

FIG. 3 depicts the “shift and add” steps of the multiplication between the constant π/2 and a 16 bit random number using a radix 4 PPG.

In FIG. 3, the 16 bit multiplier 301 is figuratively arranged to the right edge and is grouped into 8 two-bit subsets. Unlike in the Booth method, the bits in each group do not overlap. The 16-bit multiplier is partitioned to 8 2-bit subsets. Each subset is communicatively coupled to a PPG (to be described in more detail below) via a m[0] and a m[1] connection. In this embodiment, the 8 subsets of the multiplier are connected to 8 separate PPGs 310 and the outputs of the eight PPGs are channeled directly to a carry-sum adder tree 311 and a final adder 312. The final product of the multiplication 304 is then accessible from the final adder. In other implements, the subsets may be multiplexed to a smaller number of PPGs for lower hardware count and maybe lessor performance.

Referring to equations (1) through (4), it can be seen that the last bit of the equation (1) through (4) are 1, 0, 1, and 0 respectively, which represent the least significant bit of the partial products of π/2 and the numbers 11, 10, 01, and 00 respectively. These also represent the desired outputs of the least significant bit from all PPGs 310 to be delivered to the sum-carry adder 311 and is designated as output pp[0]. The other 17 outputs of the PPGs 310 are designated as pp[2] through pp[17] consecutively.

One possible way to construct the PPG with logic elements that can realize the results of equations (1) through (4) is depicted in FIG. 4:

The first output pp[0] 400 is shorted to the least significant bit of the multiplier m[0] 420. This output follows the value of m[0]: it outputs a 1 when the input from the multiplier value is 01 or 11.

Output number two pp[1] 401 is connected to the output terminal of an XOR gate 431 of which the two input terminals are connected to m[0]420 and the most significant bit of the multiplier m[1] 421 respectively. It outputs a 1 when the input from the multiplier value is 01 or 10 and therefore follows the output from the XOP gate of which the inputs are from m[0] and m[1].

Output pp[2] 402 and output pp[3] 403 are connected to the output terminal of an OR gate 432 of which the two input terminals are connected to m[0] 420 and m[1] 421.

Output pp[4] 404 is connected to the output terminal of an AND gate 433 of which one of the input terminals is connected to m[1] 421 and the other input terminal is connected to the output terminal of an INVERTER 434 of which the input is connected to m[0] 420.

Output pp[5] 405 is connected to the output terminal of an AND gate 435 of which the two input terminals are connected to m[0] 420 and m[1] 421; since the logic requirement of PP[5] 405 is identical to that of output pp[17] 407, this AND gate 435 may be shared by the pp[17] 417.

Outputs pp[6] 406, pp[7] 407, pp[10] 410, and pp[13] 413 are connected to a voltage V_{SS} 436, which stand at ground potential and in this example represents a logic value of zero.

Outputs pp[8] 408, pp[11] 411, and pp[14] 414 are connected to m[0] (420), the same input as for pp[0] 400.

Output pp[9] 409 is connected to m[1] 421, output pp[12] 412 is also connected to the same input m[1] 421.

Output pp[15] 415 is connected to an XOR gate 445, the same as pp[1] 401; therefore it may share the same XOR gate 431.

Output pp[16] 416 is connected to the output terminal of an AND gate 447 of which one of the input terminals is connected to m[1] 421 and the other input terminal is connected to the output terminal of an INVERTER 446, the input of the inverter 446 is connected to m[0] 420. Output pp[16] may share the same logic elements as output pp[4] 404 because the logic requirement of the two outputs of the PPG are identical in this example.

The function of this exemplary PPG is to generate the partial products of the constant π/2 and the binary multipliers 00, 01, 10. and 11 The PPG is configured to have two input terminals to take the partitioned multiplier for the decoder and make the partial products available at the 18 output terminals.

When the multiplier is 00, m[0] and m[1] are zero, and all 18 output terminals are zero. When the multiplier is 01, pp[0], pp[1], pp[2], pp[3], pp[8], pp[11] pp[14], and pp[15] output logic one and the other terminals output logic zero. When the multiplier is 10, pp[1], pp[2], pp[3], pp[4], pp[9], pp[12], pp[15], and pp[16] output logic one and the other terminals output zero. When the multiplier is 11, pp[0], pp[2], pp[3], pp[5], pp[8], pp[9], pp[11], pp[12], pp[14], and pp[17] output logic one; and the other terminals output logic zero.

FIG. 4 depicts only one example way of constructing a PPG with which the multiplication of constant π/2 and a two-bit multiplier can be realized. A person of ordinary skill in the art of computer engineering may arrange logic elements in other ways to yield the same result. The PPG may also take the form of a look-up table based on equations (1) through (4) above. The look-up table may be constructed with programmable logic or memory arrays, or in software programs.

The following example is implementation in radix 8 of the same multiplication of the constant π/2 to a 16-bit number. A person skilled in the art of computer science and engineering will appreciate how this implementation can reduce the number of PPGs with slightly more complex PPG construction and may follow the invention herein described in applying it to implementations using radices higher than 8.

### Example 3

### Radix 8 Multiplication of Constant π/2 to a 16 Bit Number

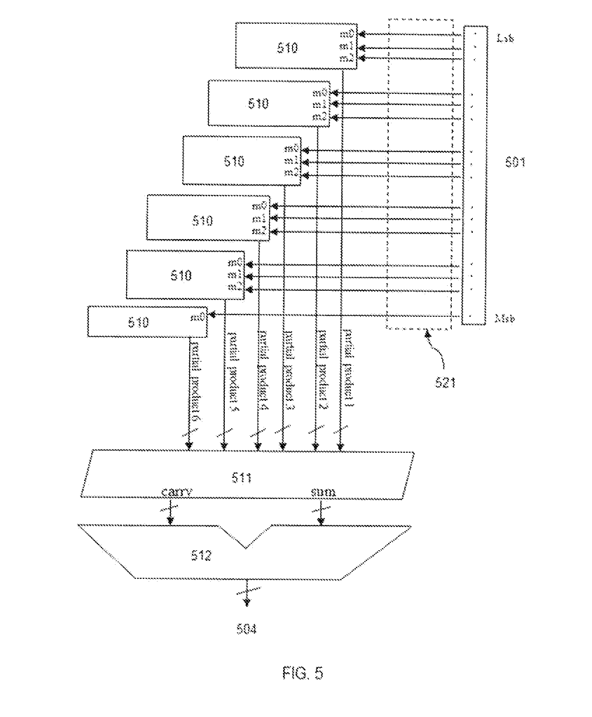

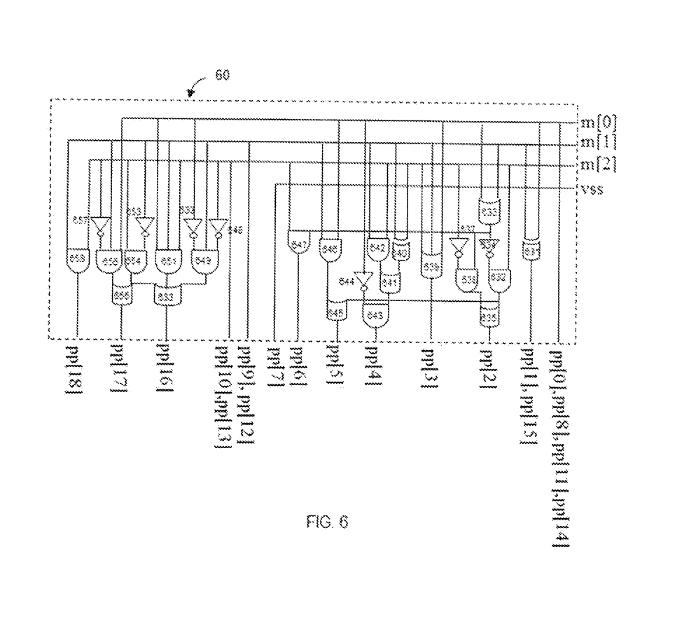

FIGS. 5 and 6 depict another illustrative embodiment of this invention, in which a constant π/2 is multiplied to a 16 bit random number 501. The difference between this embodiment and the one in example 2 is that the multiplication in this example is implemented in radix 8, in which the multiplier is grouped in three non-overlapping bits instead of two. Because the multiplier is a 16-bit number, the last sub-group after partition will only have one-bit.

In FIG. 5, the partial product generator PPG 610 is configured with 3-bit input and 19-bit output.

This exemplary PPG is also constructed with logic elements such as ADD gates, OR gates, XOR gates, INVETERs, and wires, all of which are known in the art of computer engineering. The notation pp[m] designates the m^{th} of the 19 outputs of the PPG; and m[0] is the least significant bit, m[2] is the most significant bit of the 3-bit multiplier subsets.

The binary representation of the constant π/2 is 1.100100100001111. The partial products of π/2 and the possible radix 8 binary numbers 000, 001, 010, 011, 100, 101 110, and 111 are listed in the equations below:

111×π/2=1010111111101101001 (5)

110×π/2=1001011011001011010 (6)

101×π/2=0111110110101001011 (7)

100×π/2=0110010010000111100 (8)

011×π/2=0100101101100101101 (9)

010×π/2=0011001001000011110 (10)

001×π/2=0001100100100001111 (11)

000×π/2=0000000000000000000 (12)

FIG. 5 depicts the shift and add steps of the multiplication between the constant π/2 and a 16 bit number using radix 8 PPGs.

In FIG. 5, the 16 bit multiplier 501 is arranged figuratively to the right and is grouped into five 3-bit subsets and one single bit subset. Each subset is connected to a PPG (to be described in more detail below) via a m[0] a m[1], and a m[2] connection. The single bit subset may be connected to a PPG of one-bit input or a three-bit input with m[1] and m[2] fixed at Vss. In this embodiment, each subset of the multiplier is connected to a separate and maybe identical PPG 510 and the 19-bit outputs of the eight PPGs are channeled directly to a carry-sum adder tree 511 and a final adder 512. The final product of the multiplication 504 is then accessible from the final adder 512. In other implements, the subsets may be multiplexed to a smaller number of PPGs at a lower hardware count and maybe lessor performance.

Referring to equations (5) through (12), it can be seen that the last bit of the equation (5) through (12) are 1, 0, 1, 0, 1, 0,1, and 0 respectively, which represent the least significant bit of the partial products of π/2 and the numbers 111, 110, 101, 100, 011, 010, 001 and 000 respectively. These also represent the desired outputs of the least significant bit from all PPGs 510 to be delivered to the sum-carry adder 511 and is designated as output pp[0]. The other outputs of the PPGs 510 are designated as pp[2] through pp[18] consecutively.

One possible way to construct the PPG with logic elements that can realize the results of equations (5) through (12) is depicted in FIG. 6 as follows:

Outputs pp[0], pp[8], pp[11], and pp[14] are shorted to the least significant bit of the multiplier m[0]. This output outputs a 1 when the LSB of the multiplier value is 1, and 0 when the LSB is 0: thus pp[8], pp[11], and pp[14] has the same as the logic value of m[0].

Outputs pp[1] and pp[5] are connected to the output terminal of an XOR gate 631 of which the two input terminals are connected to m[0] and m[1]. Again, referring back to equation (5) through (12), it can be seen that the output bits [1] and [5] from all PPGs 510 should output a 1 only when m[0] and m[1] do not have the same value, regardless of m[2].

A person with ordinary skill in the art of computer science and engineering can follow the logic diagram of FIG. 6 to understand and to reproduce a PPG that efficiently performs the multiplication of the constant π/2 to a random 16 bit number.

### Example 4

### Multiplication of Constant 1/LN(2) to a 16 Bit Random Number

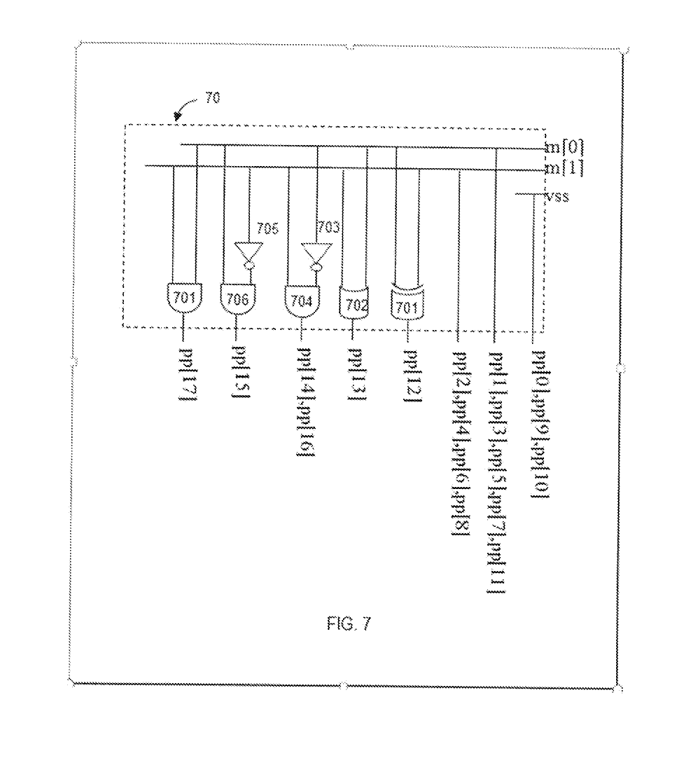

The constant 1/LN(2)—the reciprocal of the natural Log 2—is another constant frequently encountered in modern computer science and engineering. FIG. 7 depicts an illustrative embodiment of PPG that implement the multiplication of this constant and a random number. In decimal representation 1/LN(2) equals 1.4426; and in 18 bit binary representation it is expressed as 00 1100 1001 0000 1111.

FIG. 7 depicts one possible construction of a PPG for multiplying 1/LN(2). The PPG may be constructed in a single integrated circuit chip with ADD gates, OR gates, XOR gates, INVETERs, and wires, all of which are known in the art of computer engineering. Similarly the notation pp[m] designates the m^{th} of the 18 outputs of the PPG; and m[0] is the least significant bit and m[1] is the most significant bit of the 2-bit multiplier subsets.

The partial products of 1/LN(2) and the two-bit binary numbers 00, 01, 10, and 11 are listed in the equations below:

11×1/LN(2)=100010100111111110 (13)

10×1/LN(2)=010111000101010100 (14)

01×1/LN(2)=001011100010101010 (15)

00×1/LN(2)=000000000000000000 (16)

FIG. 3 depicts the “shift and add” steps of the multiplication between the constant 1/LN(2) and a 16 bit number using radix 4 PPGs.

In FIG. 3, the 16 bit multiplier 301 is figuratively arranged to the right edge and is grouped into 8 two-bit subsets. Each subset is connected to a PPG (to be described in more detail below) via a m[0] and a m[1] connection. In this embodiment, each subset of the multiplier is connected to a separate PPG 310 and the outputs at the output terminals of the eight PPGs are channeled directly to a carry-sum adder tree 311 and a final adder 312. The final product of the multiplication 304 is then accessible from the final adder. In other implements, the subsets may be multiplexed to a smaller number of PPGs for lower hardware count and maybe lessor performance.

Referring to equations (13) through (16), it can be seen that the last bit of the equation (13) through (16) are all 0 s, which represent the least significant bit of the partial products of 1/LN(2) and the numbers 11, 10, 01, and 00. The all zero string also represents the desired outputs of the least significant bit from all PPGs 310 to be delivered to the sum-carry adder 311 at output terminal pp[0]. The other outputs of the PPGs 310 are designated as pp[2] through pp[17] consecutively.

One possible way to construct the PPG with logic elements that can realize the results of equations (1) through (4) is depicted in FIG. 7 as follows:

The first output pp[0] is shorted to the least significant bit of the multiplier m[0]. This output outputs a 1 when the input from the multiplier value is 01 or 11 and therefore output pp[0] follows the logic value of m[0].

From equation (13) through (16) it can be observed that not only output pp[0] is a null output but also are pp[9] and pp[10] and this can be accomplished by tying these outputs directly to Vss. Outputs pp[1], pp[3], pp[5], pp[7], and pp[11] can be observed as follow the logic value of m[0] so in the PPG, these outputs can be directly wired to the input m[0]. Outputs pp[2], pp[4], pp[6], and pp[8] follow the logic value of mill and thus can be constructed by wiring these outputs to input terminal m[1]. Output at pp[12] is a 1 only when input at m[0] and m[1] are not both 1 or 0 so it can be built with a XOR gate with one input wired to m[0] and the other input wired to m[1].

For brevity, the construction of the remaining outputs pp[13] through pp[17] is not described but it can be gleaned from observing equations (13) through (16) and by following FIG. 7.

The following example is a radix 8 implementation of the same multiplication of the constant 1/LN(2) to a 16-bit number. A person skilled in the art of computer science and engineering will appreciate how this implementation can reduce the number of PPGs with slightly more complex PPG construction and may follow the invention herein described in applying it to implementations using radices higher than 8.

### Example 5

### A Radix 8 Multiplication of Constant 1/LN(2) to a 16 Bit Number

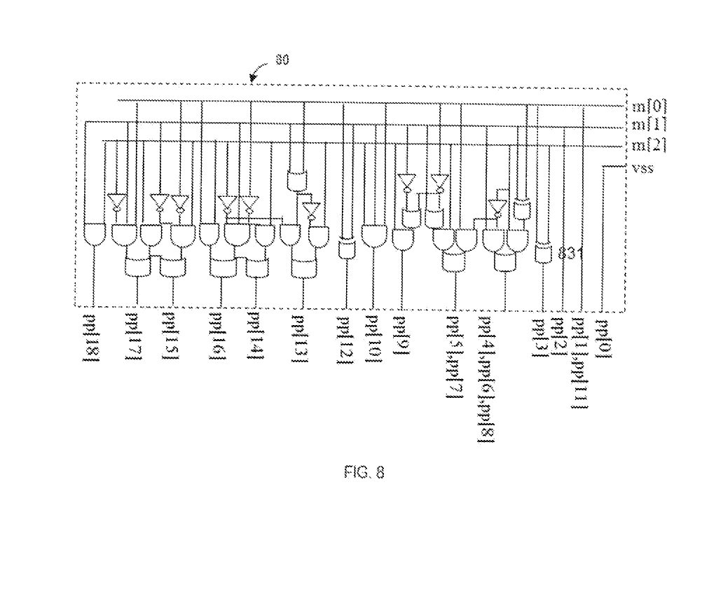

FIGS. 5 and 8 depict another illustrative embodiment of this invention, in which the constant 1/LN(2) is multiplied to a 16 bit decoded number 501. The difference between this embodiment and the one in example 4 is that the multiplication in this example is implemented in radix 8, in which the multiplier is grouped in three bits instead of two. Because the multiplier is a 16-bit number, the last subset will only have one-bit.

In FIG. 5, the partial product generator PPG 510 is configured with 3 input terminals and 19 output terminals.

This exemplary PPG is also constructed with ADD gates, OR gates, XOR gates, INVETERs, and wires in a single integrated circuit chip, all of which are known in the art of computer engineering. The notation pp[m] designates the m^{th} of the 19 outputs of the PPG; and m[0] is the least significant bit, m[2] is the most significant bit of the 3-bit multipliers.

The binary representation of the constant 1/LN(2) is 1.011100010101010. The partial products of 1/LN(2) and the three-bit binary numbers 000, 001, 010, 011, 100, 101 110, and 111 are listed in the equations below:

111×1/LN(2)=1010000110010100110 (17)

110×1/LN(2)=1000101001111111100 (18)

101×1/LN(2)=0111001101101010010 (19)

100×1/LN(2)=0101110001010101000 (20)

011×1/LN(2)=0100010100111111110 (21)

010×1/LN(2)=0100111000101010100 (22)

001×1/LN(2)=0001011100010101010 (23)

000×1/LN(2)=0000000000000000000 (24)

FIG. 5 depicts the “shift and add” steps of the multiplication between the Constant 1/LN(2) and a 16 bit random number using radix 8 PPGs.

In FIG. 5, the 16 bit multiplier 501 is arranged figuratively to the right and is grouped into five 3-bit subsets and one single bit subset. Each subset is connected to a PPG via a m[0], a m[1], and a m[2] connection. The single bit subset may be connected to a PPG of one-bit input or a three-bit input with m[1] and m[2] fixed at Vss. In this embodiment, each subset of the multiplier is connected to a separate and maybe identical PPG 510 and the 19-bit outputs of the eight PPGs are channeled directly to a carry-sum adder tree 511 and a final adder 512. The final product of the multiplication 504 is then accessible from the final adder 512. In other implements, the subsets may be multiplexed to a smaller number of PPGs at a lower hardware count and maybe lessor performance.

Referring to equations (13) through (18), it can be seen that the last bits of the equation (13) through (18) are all zero, which represent the least significant bit of the partial products of 1/LN(2) and the numbers 111, 110, 101, 100, 011, 010, 001 and 000 respectively. These also represent the desired outputs of the least significant bit from all PPGs 510 to be delivered to the sum-carry adder 511 and is designated as output pp[0]. The other outputs of the PPGs 510 are designated as pp[2] through pp[18] consecutively.

One possible way to construct the PPG with logic elements that can realize the results of equations (13) through (18) is depicted in FIG. 8.

From equations (13) through (18) it can be observed that the LSBs of all partial products are zero. This leads to a simple construction of output pp[0], i.e., directly wiring of output pp[0] terminal to Vss, as depicted in FIG. 8. From equations (13) through (18) one can further observe that outputs pp[1] and pp[11] follow the logic value of m[0]; and the, output pp[2] follows the value of m[1]. Therefore the PPG can be constructed by directly wiring the respective input terminals to the output terminals.

Output pp[3] and output pp[12] can be constructed each with a single XOR gate wired to m[0], m[2] and m[0], m[1] respectively, as depicted in FIG. 8.

Following the explanation, a person with ordinary skill in computer engineering can readily build a PPG depicted in FIG. 8 following the drawing figure.

### Example 6

### Partial Product Generator for a Random Number

There are occasions when both operands are not known until they arrive at the multiplication circuitry. In dealing with such occasions, the partial product generator may be formed in the form of look-up tables and store the look-up tables in computer memory by following the description below.

Upon the arrival of the first operand, partial products of the operand and the possible sub-groups of multiplier can be generated according to a predetermined radix such as according to equations (1) through (18) above and stored the partial products in computer memory and be selectably accessible via an address bus.

When the late-arriving operand is available, it may be decoded according to the predetermined radix and then stored in memory communicatively coupled to the look-up table. The connection may be via direct bus so each subset of the multiplier is directly coupled to a copy of the table, or it may be via a multiplexor in which case the look-up table is accessible to a plurality of subsets of the multiplier.

The procedure of multiplication of two random numbers can then proceed following the examples as depicted in FIGS. 3 and 5 for radix 4 and radix 8. A person with ordinary skill in the art of computer science and engineering may extrapolate from these teaching to implement multiplications of other radices.

The block diagram depicted in FIGS. 3 and 5 and the PPGs depicted in FIGS. 4, 6, 7, and 8 may be a portion of a computation device built in a single integrated circuit chip. The PPGs may be aggregated in one general location or they may be dispersed in different locations of the chip.

We claim:

1. A partial product generator, comprising:
a first number of input terminals, the first number not smaller than two;
a second number of output terminals;
the input terminals configured to receive a signal representing the value of a third number; and
logic elements configured to generate multiplication product between the third number and one predetermined constant and to communicate the multiplication product to the output terminals.

2. The partial product generator of claim 1, in which the logic elements comprising AND gate, OR gate, and XOR gate.

3. A computation device comprising more than one partial generator of claim 1.

4. The computation device of claim 3, further comprising a memory unit for storing a multiplier.

5. The computation device of claim 4, further comprising a decoder to partition the multiplier into a fourth number of subsets of non-overlapping binary numbers of a radix.

6. The computation device of claim 5, in which the number of partial product generator equals the fourth number.

7. The computation device of claim 6, further configured to couple each of the decoded subsets of the multiplier to a partial product generator.

8. The computation device of claim 7, further configured to communicatively couple the output terminals to a carry-save adder tree.

9. The computation device of claim 8, further configured to communicatively couple the carry-save adder tree to a adder.

10. A integrated circuit chip comprising a partial product generator of claim 1.

11. A integrated circuit chip comprising a computation device of claim 9.

12. A method of multiplying a random number and constant, comprising:
receiving the random number in a memory unit;
partitioning the random number into a first number of subsets of non-overlapping binary bits of a radix;
communicatively coupling each of the groups of binary bits to a partial product generator configured to multiply the each of the groups of binary bits to one predetermined constant.

13. The method of claim 12, in which each of the subsets of non-overlapping binary bits is communicatively coupled to a separate partial product generator.

14. The method of claim 12, in which more than one of the subsets of non-overlapping binary bits are communicatively coupled to a partial product generator via a multiplexor.
